(19) United States
(12) Patent Application Publication
(10) Pub. No.: US 2026/0080389 A1
(43) Pub. Date: Mar. 19, 2026

(54) COORDINATED REMOTE PAYMENT BETWEEN INITIATOR AND PAYOR ELECTRONIC DEVICES

(71) Applicant: MOTOROLA MOBILITY LLC, WILMINGTON, DE (US)

(72) Inventors: KRISHNAN RAGHAVAN, BANGALORE (IN); NAKUL PATEL, NAGPUR (IN); VIJAYPRAKASH IDLUR, BANGALORE (IN)

(21) Appl. No.: 18/887,547

(22) Filed: Sep. 17, 2024

(51) Int. Cl. G06Q 20/32; G06Q 20/02; G06Q 20/42

(52) U.S. Cl. CPC G06Q 20/3276; G06Q 20/02; G06Q 20/42

(57) ABSTRACT

An electronic device, a method, and a computer program product facilitate and expedite remote payor approval of a payment request by an initiator at a payee point of sale. A controller of the electronic device receives, via input device(s), a payment code for providing payment to a payee. In response, controller automatically initiates generation of a payment request including the payment code for communicating to a payor device: Controller prompts for entry of a user authentication input to confirm the payment request as originating from a known/trusted payment requester within a group. Controller verifies a received user authentication input and transmits, via the communications subsystem, a verified payment request to the first payor device. The verified payment request includes metadata that confirms that the payment request is an authentic request originating from the known/trusted payment requester and triggers an output of the authentic payment request by the payor device.

### BACKGROUND

### 1. Technical Field

The present disclosure relates generally to mobile electronic devices having a communications subsystem for data communication, and more particularly to mobile electronic devices having a communications subsystem for user authenticated data communication with the other user electronic device.

### 2. Description of the Related Art

As technology has advanced, uses for mobile electronic devices have expanded to include peer-to-peer (P2P) instant purchases. Instead of having to present currency or a credit/debit card, the mobile electronic device may be preloaded with credentials to initiate a payment to a payee. Increasingly, payees are including payment information at a point of sale (POS) in the form of a website link or quick response (QR) code or a barcode at a POS location. With this information, a payor is able to make the payment to a financial account of the payee by using their mobile electronic device.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 presents a simplified functional block diagram of an electronic device in which the features of the present disclosure are advantageously implemented to facilitate and expedite remote payor approval of a payment request by an initiator at a payee point of sale, according to one or more embodiments;

FIG. 2 is an example three-party communications timing diagram of a communications environment of FIG. 1 having user devices and network devices supporting distinct roles for initiator, payor, and payee to complete a peer-to-peer (P2P) payment transaction, according to one or more embodiments;

FIG. 3 illustrates a display of a communication device of FIG. 1 presenting a “pay with quick response (QR) code” window configured for an initiator within a group, according to one or more embodiments;

FIG. 4 illustrates the display of the communication device presenting a remote payment request (RPR) window configured for the initiator, according to one or more embodiments;

FIG. 5 illustrates a display of a second communication device of FIG. 1 presenting a remote payment request (RPR) window configured for a payor within the group, according to one or more embodiments;

FIG. 6 illustrates a display of a third communication device of FIG. 1 presenting a forwarded remote payment request (FRPR) window configured for a subsequent payor within the group, according to one or more embodiments;

FIG. 7 illustrates the display of the communication device presenting a remote payment request status (RPRS) window configured for an initiator within the group, according to one or more embodiments;

FIG. 8A-8C (collectively “FIG. 8”) are a flow diagram presenting a method performed at an initiator device for facilitating and expediting remote payor approval of a payment request for payment for a transaction by an initiator at a payee point of sale, according to one or more embodiments; and

FIG. 9A-9B (collectively “FIG. 9”) are a flow diagram presenting a method performed by a requested payor device for receiving an authenticating payment request from an initiator as a trusted person within a group and approving, declining, or forwarding the payment request by a payor within the group.

### DETAILED DESCRIPTION

According to aspects of the present disclosure, an electronic device, a method, and a computer program product facilitate and expedite remote payor approval of a payment request by an initiator who is presented a purchase offer by a payee. In an example, a product may be physically available at a point of sale (POS). A human payee may be present at the POS. Alternatively, a payee may not be physically present at the POS with product delivery being provided by an automated store or vending machine. In one or more embodiments, the purchase offer for payment of a transaction for product may be a physical or digitally presented offer (e.g., billboard or webpage) that triggers remote delivery of a purchased product. Although significant development of technology required for peer-to-peer (P2P) payments has occurred, some individuals do not have the financial means or authority to engage in a P2P transaction on their own. As an example, young people and tech-adverse individuals may struggle with digital accounts or digital security features. Without benefit of the present disclosure, the workarounds to let these individuals participate in P2P transactions are cumbersome and sometimes ineffective. These individuals occasionally rely on requesting payments from a known individual, such as a parent or other family member, by transmitting a payment request to the known individual. The payment request can be sent by texting and/or emailing quick response (QR) codes to a family member; However, the recipient family member may not recognize that the request is legitimate and may ignore the request. The individual may try to work out alternate payment solutions with a merchant, which process can be time-consuming and inconvenient to both parties. The present disclosure recognizes this need and provides solutions to enhance inclusivity and efficiency of P2P transactions, offering a seamless way for users to request payment assistance and for a receiving user to verify the request is legitimate and provide financial assistance securely and promptly. The solutions provide a communication flow in a three-party P2P payment transaction between user devices and network device(s) that support distinct roles for initiator, payor, and payee. In one or more embodiments, the payee is supported by network device(s) that receive a payment. In one or more embodiments, the payee is also supported by a user device that presents a payment code. In one or more embodiments, the payee is also supported by a user device that receives a notification of receipt of a payment at network device(s).

In one or more embodiment, the electronic device includes at least one input device and at least one output device. The electronic device includes a memory having a third-party payment module for coordinated remote payment by at least one third-party payor. The electronic device includes a communications subsystem that links the electronic device to one or more second electronic devices designated as part of a group that includes at least one initiator device and at least one payor device. A controller is communicatively coupled to the at least one input device, the at least one output device, the memory, and the communications subsystem. The controller is configured to cause the electronic device to receive, via the at least one input device, a payment code for providing payment to a payee. In response to receiving the payment code, the controller is configured to cause the electronic device to automatically initiate generation of a payment request comprising the payment code for communicating to a first payor device among the at least one payor device. In response to detecting the automatic generation of the payment request, the controller is configured to cause the electronic device to prompt for entry of a user authentication input to confirm the payment request as originating from a known/trusted payment requester within the group. The controller is configured to cause the electronic device to verify, via the third-party payment module that a received user authentication input matches a pre-established payment request authentication verifier for payment requests originating from the known/trusted payment requester. The controller is configured to cause the electronic device to transmit, via the communications subsystem, a verified payment request to the first payor device only after receipt of the user input that matches the pre-established payment request authentication verifier. The verified payment request includes metadata that confirms that the payment request is an authentic request originating from the known/trusted payment requester and triggers an output of the authentic payment request via an output device of the first payor device.

Aspects of the present disclosure address frustrations experienced by a payment request initiator, whose third-party-communicated request for payment are ignored and/or go unanswered by the potential recipient payor. The payee is able to provide contextual information to confirm the legitimacy of the request. The payee is able to see the status of the request and respond to a delay by communicating by voice or text directly with the payor or by forwarding the request to a second payor. Additional aspects of the present disclosure also address frustrations experienced by the remote payor, who may inadvertently provide payment to a fraudulent request that the payor believes may be for a transaction by someone the payor supports. The present disclosure can also thwart fraudulent attempts to get a remote payor to approve a payment to malevolent third parties by requiring the requesting party to authenticate the request and provide contextual information to indicate legitimacy. With the benefits of the present disclosure, the payor is less likely to approve a fraudulent payment request and also less likely to decline a request by inadvertently inferring that the legitimate request is fraudulent.

In the following detailed description of exemplary embodiments of the disclosure, specific exemplary embodiments in which the various aspects of the disclosure may be practiced are described in sufficient detail to enable those skilled in the art to practice the invention, and it is to be understood that other embodiments may be utilized and that logical, architectural, programmatic, mechanical, electrical, and other changes may be made without departing from the spirit or scope of the present disclosure. The following detailed description is, therefore, not to be taken in a limiting sense, and the scope of the present disclosure is defined by the appended claims and equivalents thereof. Within the descriptions of the different views of the figures, similar elements can be provided with similar names and reference numerals as those of the previous figure(s). The specific numerals assigned to the elements are provided solely to aid in the description and are not meant to imply any limitations (structural or functional or otherwise) on the described embodiment. It will be appreciated that for simplicity and clarity of illustration, elements illustrated in the figures have not necessarily been drawn to scale. For example, the dimensions of some of the elements are exaggerated relative to other elements.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

As further described below, implementation of the functional features of the disclosure described herein is provided within processing devices and/or structures and can involve use of a combination of hardware, firmware, as well as several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general invention. The description of the illustrative embodiments can be read in conjunction with the accompanying figures. Embodiments incorporating teachings of the present disclosure are shown and described with respect to the figures presented herein.

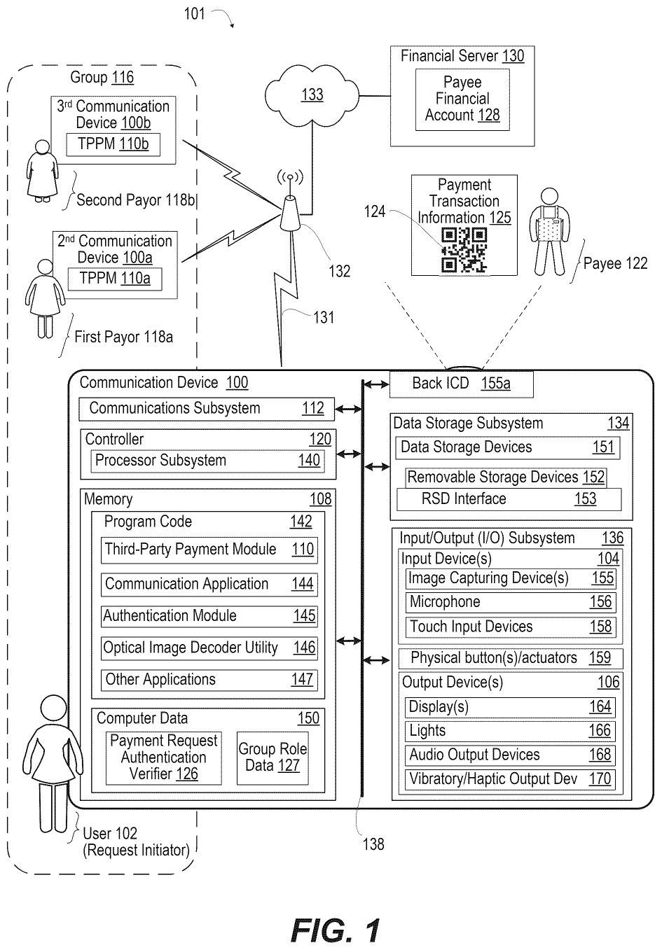

FIG. 1 presents a simplified functional block diagram of an electronic device in which the features of the present disclosure are advantageously implemented to facilitate and expedite remote payor approval of a payment request by an initiator. In an example, the initiator is at a payee point of sale (POS). In one or more embodiments, the electronic device includes additional communications functionality that enables electronic device to be referred to as communication device 100, which operates as a mobile user device for user 102 in communication environment 101. Communication device 100 can be one of a host of different types of devices, including but not limited to, a mobile cellular phone, satellite phone, or smart phone, a laptop, a netbook, an ultra-book, a networked smartwatch, or networked sports/exercise watch, and/or a tablet computing device or similar device that can include wireless communication functionality. As a device supporting wireless communication, communication device 100 can be utilized as, and also be referred to as, a system, device, subscriber unit, subscriber station, mobile station (MS), mobile, mobile device, remote station, remote terminal, user terminal, terminal, user agent, user device, a session initiation protocol (SIP) phone, a wireless local loop (WLL) station, a personal digital assistant (PDA), computer workstation, a handheld device having wireless connection capability, a computing device, or other processing devices.

Communication device 100 includes input device(s) 104 and output device(s) 106. Communication device 100 includes memory 108 that stores third-party payment module 110 for coordinated remote purchase by at least one third-party payor. Communication device 100 includes communications subsystem 112 that links communication device 100 to one or more second electronic devices designated as part of group 116 that includes at least one initiator device (e.g., communication device 100) and at least one payor device (e.g., second and third communication devices 100a and 100b used respectively by first payor 118a and second payor 118b). In an example, group 116 includes family members or close friends, some of which do not have means or authority to make purchases on their own behalf. Group 116 may be termed a “close knit group” of two or more people. In one or more embodiments, group 116 has additional functionality for sharing location information, controlling screen time and types of content accessed by others in group 116, etc. Individual users within group 116 can be assigned privileges or authority to control a communication device assigned to another individual user in group 116. The privileges or authority may be defined as a role. Authentication credential given to a particular user enables identifying a user and associating at least one role assigned to the user. In the specific example of FIG. 1, communications subsystem 112 of communication device 100 connects via wired or wireless channel 131 to node 132 (e.g., wireless access point, cellular tower) to communicatively connect via communications network 133 to second and third communication devices 100a and 100b, which may include identical or similar components to communication device 100.

Controller 120 of communication device 100 is communicatively coupled to input device(s) 104, output device(s) 106, memory 108, and communications subsystem 112. Controller 120 is configured to cause communication device 100 to receive, via input device(s) 104, a payment code for providing payment to payee 122. In an example, QR code 124 presented as or part of payment transaction information (PTI) 125 provides the payment code. In response to receiving the payment code, controller 120 configures communication device 100 to automatically initiate generation of a payment request that includes the payment code for communicating to first payor device (e.g., communication device 100a) among the at least one payor device. In response to detecting generation of the payment request, controller 120 configures communication device 100 to prompt for entry of a user authentication input via input device(s) 104 to confirm the payment request as originating from a known/trusted payment requester (i.e., user 102) within group 116. Controller 120 configures communication device 100 to verify, via third-party payment module 110, that a received user authentication input matches pre-established payment request authentication verifier 126 in memory 108 for payment requests originating from the known/trusted payment requester (i.e., user 102). Group role data 127 in memory 108 provides a cross reference of users (102, 118a and 118b) that are members of group 116. Group role data 127 includes any role (e.g., none, initiator, or payor) assigned to each user. Group role data 127 includes at least one communication address (e.g., telephone voice or short message service (SMS) number) or communication device identifier associated with each user. Controller 120 configures communication device 100 to transmit, via communications subsystem 112, a verified payment request to the first payor device (e.g., communication device 100a) only after receipt of the user input that matches pre-established payment request authentication verifier 126. The verified payment request includes metadata that confirms that the payment request is an authentic request originating from the known/trusted payment requester (i.e., user 102) and triggers an output of the authentic payment request via output device(s) of the first payor device (e.g., communication device 100a). Presentation of the payment request may trigger payment to payee financial account 128. In an example payee financial account 128 is accessed via financial server 130. Alternatively, the payment request may be declined by the requested payor, which may prompt/trigger communication device 100 resending the payment request to another payor device (e.g., third communication device 100b).

In addition to memory 108, communications subsystem 112 and controller 120, communication device 100 may include data storage subsystem 134 and input/output (I/O) subsystem 136. To enable management by controller 120, system interlink 138 communicatively connects controller 120 with memory 108, communications subsystem 112, data storage subsystem 134 and I/O subsystem 136. System interlink 138 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components. Although certain direct interconnections (i.e., system interlink 138) are illustrated in FIG. 1, it is to be understood that more, fewer, or different interconnections may be present in other embodiments.

Controller 120 includes processor subsystem 140, which includes one or more central processing units (CPUs) or data processors. Processor subsystem 140 can include one or more digital signal processors (DSPs), graphics processing unit (GPU), image capture device (ICD) controller, and hardware acceleration (HA) unit that can be integrated with data processor(s). Processor subsystem 140 can, in some embodiments, include image signal processors (ISPs) (not shown) and dedicated artificial intelligence (AI) engines. In one or more embodiments, processor subsystem 140 can execute AI modules to provide AI functionality of AI engines. AI modules may include an artificial neural network, a decision tree, a support vector machine, Hidden Markov model, linear regression, logistic regression, Bayesian networks, and so forth. The AI modules can be individually trained to perform specific tasks and can be arranged in different sets of AI modules to generate different types of output. Processor subsystem 140 can interchangeably be referred to as controller 120.

For simplicity in describing the features of communication device 100, the functionality provided by one or more of CPU, DSP, GPU, ISP/ICD controller, etc. are collectively described as being performed by processor subsystem 140 (or controller 120). Collectively, components integrated within processor subsystem 140 support computing, classifying, processing, transmitting and receiving of data and information, and presenting of graphical images within a display, etc. Processor subsystem 140 can include other processors such as auxiliary processor(s) that may act as a low power consumption, always-on sensor hub for physical sensors. Controller 120 manages, and in some instances directly controls, the various functions and/or operations of communication device 100. These functions and/or operations include, but are not limited to including, application data processing, communication, navigation tasks, image processing, and signal processing. In one or more alternate embodiments, communication device 100 may use hardware component equivalents for application data processing and signal processing. For example, communication device 100 may use special purpose hardware, dedicated processors, general purpose computers, microprocessor-based computers, micro-controllers, optical computers, analog computers, dedicated processors and/or dedicated hard-wired logic.

Memory 108 stores program code 142 for execution by processor subsystem 140 to provide several aspects of the functionality described herein. Program code 142 includes applications such as third-party payment module 110, communication application 144, authentication module 145, optical image decoder utility 146, and other applications 147. In one or more embodiments, several of the described aspects of the present disclosure are provided via executable program code of applications executed by controller 120. Controller 120 is configured by program code 142 to perform functionality described herein. In an example, third-party payment module 110 identifies the role of user 102 within group 116 as contained in group role data 127 and configures communication device 100 for the role. In an example, the role of user 102 is payment initiator. In response to identifying the role of payment initiator, third-party payment module 110 configures communication device 100 for payment initiation. In another example, third-party payment module (TPPM) 110a configures second communication device 100a to determine, based on a local copy of group role data 127, that the role of first payor 118a within group 116 is payor. In response, TPPM 110a configures second communication device 100a to enable the corresponding user to approve, decline or forward processing of payment requests received from user 102 or from another payor (118b). Similarly, TPPM 110b configures third communication device 100b to determine, based on a local copy of group role data 127, that the role of second payor 118b within group 116 is payor. In response, TPPM 110b configures third communication device 100b to enable the corresponding user to approve, decline, or forward processing payment requests received from user 102 or from another payor (118a). Communication application 144 supports person to person voice, video, or text communications as requested between initiator and payor. In one or more embodiments, haptic/kinematic output (e.g., Braille) may be provided for a user unable to perceive visual information. In one or more embodiments, image input detection may support receiving and recognizing gesture-based language inputs. Authentication module 145 determines whether user 102 is in group 116 and the assigned role within group 116. Optical image decoder utility 146 automatically recognizes visually presented payment information captured by communication device 100. In one or more embodiments, program code 142 may be integrated into a distinct chipset or hardware module as firmware that operates separately from executable program code. Portions of program code 142 may be incorporated into different hardware components that operate in a distributed or collaborative manner. Memory 108 further includes operating system (OS), firmware interface, such as basic input/output system (BIOS) or Uniform Extensible Firmware Interface (UEFI), and firmware, which also includes and may thus be considered as program code 142.

Program code 142 may access, use, generate, modify, store, or communicate computer data 150, such as payment request authentication verifier 126 for communication device 100 to use, backup and restore. Computer data 150 may incorporate “data” that originated as raw, real-world “analog” information that consists of basic facts and figures. Computer data 150 includes different forms of data, such as numerical data, images, coding, notes, and financial data. Computer data 150 may originate at communication device 100 or be retrieved from a remote device via communications subsystem 112. Communication device 100 may store, modify, present, or transmit computer data 150, such as payment request authentication verifier 126. Computer data 150 may be organized in one of a number of different data structures. Common examples of computer data 150 include video, graphics, text, and images. Computer data 150 can also be in other forms of flat files, databases, and other data structures.

Data storage subsystem 134 of communication device 100 includes data storage device(s) 151. Controller 120 is communicatively connected, via system interlink 138, to data storage device(s) 151. Data storage subsystem 134 provides program code 142 and computer data 150 stored on nonvolatile storage that is accessible by controller 120. For example, data storage subsystem 134 can provide a selection of program code 142 and computer data 150. These applications can be loaded into memory 108 for execution/processing by controller 120. In one or more embodiments, data storage device(s) 151 can include hard disk drives (HDDs), optical disk drives, and/or solid-state drives (SSDs), etc. Data storage subsystem 134 of communication device 100 can include removable storage device(s) (RSD(s)) 152 which is received in RSD interface 153. Controller 120 is communicatively connected to RSD 152, via system interlink 138 and RSD interface 153. In one or more embodiments, RSD 152 is a non-transitory computer program product or computer readable storage device that stores program code and/or instructions that may be executed by a processor associated with an electronic device such as communication device 100. Controller 120 can access data storage device(s) 151 or RSD 152 to provision communication device 100 with program code 142 and computer data 150.

I/O subsystem 136 may include input device(s) 104 such as image capturing device(s) 155, microphone 156, and touch input devices 158 (e.g., screens, keys, or buttons). I/O subsystem 136 may include physical buttons/actuators 159 that can be located on a periphery of the device housing. I/O subsystem 136 may include output device(s) 106 such as display(s) 164, lights 166, audio output devices 168, and vibratory or haptic output devices 170. User 102 may position communication device 100 so that a camera preview is viewable on a front touch screen of display(s) 164 and back image capturing device 155a has a field of view that contains payment transaction information (PTI) 125.

In one or more embodiments, controller 120, via communications subsystem 112, performs multiple types of cellular over-the-air (OTA) communication. In one or more embodiments, controller 120, via communications subsystem 112, may communicate via an OTA cellular connection with radio access networks (RANs). In an example, communication device 100, via communications subsystem 112, connects via RANs of a terrestrial network that is communicatively connected to a network server. In one or more embodiments, controller 120, via communications subsystem 112, communicates via a wireless local area network (WLAN) link using one or more IEEE 802.11 WLAN protocols with an access point. In one or more embodiments, controller 120, via communications subsystem 112, performs other types of wireless communication, such as by using a Bluetooth connection or other personal access network (PAN) connection. In an example, a user may wear a health monitoring device such as a smartwatch that is communicatively coupled to communication device 100 via a wireless connection. In one or more embodiments, communications subsystem 112 includes a global positioning system (GPS) module that receives GPS broadcasts from GPS satellites to obtain geospatial location information, which enables communication device 100 to self-locate, among other features.

In one or more embodiments, controller 120 configures communication device 100 to receive, via communications subsystem 112, a transmitted payment decision status from among a payment confirmation notification or a declined payment notification from the first payor device (e.g., second communication device 100a). Controller 120 configures communication device 100 to output the received payment decision status via output device(s) 106. In one or more particular embodiments, to output the received payment decision status, controller 120 configures communication device 100 to render a purchase control interface containing the payment decision status. Controller 120 configures communication device 100 to modify display(s) 164 to present the purchase control interface.

In one or more embodiments, in response to determining that the received payment decision status indicates that the first payor has declined to provide the payment, controller 120 configures communication device 100 to identify second payor 118b, assuming one is available, within group 116. Second payor 118b has an associated second payor device (e.g., third communication device 100b). Controller 120 configures communication device 100 to communicate the verified payment request via communications subsystem 112 to the second payor device (e.g., third communication device 100b) to prompt review and approval by second payor 118b via the second payor device of a payment in response to the verified payment request.

In one or more embodiments, controller 120 configures communication device 100 to receive a payment receipt for the purchase associated with the payment code. In response to determining that the payment receipt is received, controller 120 configures communication device 100 to render the purchase control interface containing the payment receipt. Controller 120 configures communication device 100 to modify display(s) 164 on output device(s) 106 to present the purchase control interface to enable viewing of the payment receipt confirming completion of the payment.

In one or more embodiments, controller 120 configures communication device 100 to capture, using image capturing device(s) 155, a scanned image including the payment code. The scanned image includes a one-dimensional barcode or a two-dimensional barcode containing payment request information indicating a recipient account and a payment amount. Controller 120 configures communication device 100 to autonomously transmit at least one of the scanned image and the payment information within the verified payment request to second communication device 100a only after receipt of the user input that matches the pre-established payment request authentication verifier.

In one or more embodiments, controller 120 configures communication device 100 to capture a plurality of character images as the payment code. Controller 120 configures communication device 100 to perform optical character recognition of the character images to identify a recipient account and a payment amount. Controller 120 configures communication device 100 to transmit the recipient account and payment amount within the verified payment request to second communication device 100a.

In one or more embodiments, controller 120 configures communication device 100 to, prior to communicating the payment code, render a payment control interface containing a prompt for entry of purchase explanatory information. Controller 120 configures communication device 100 to receive the purchase explanatory information via input device(s) 104. Controller 120 configures communication device 100 to communicate the verified payment request with the purchase explanatory information.

In one or more embodiments, in response to determining that the received payment decision status has not been received during a threshold period of time, controller 120 configures communication device 100 to communicate the payment code via communications subsystem 112 to a third electronic device (i.e., third communication device 100b) of the at least one second electronic device. Third communication device 100b is used by second payor 118b who is part of group 116. Communication device 100 communicates the verified payment request to prompt review and approval by second payor 118b via third communication device 100b of the purchase associated with the payment code.

In one or more embodiments, in response to receiving a communication request from the first payor device (e.g., second communication device 100a) subsequent to communicating the verified payment request, controller 120 configures communication device 100 to render and output, via output device(s) 106, a communication interface responsive to the communication request. Controller 120 configures communication device 100 to communicate, via communications subsystem to the first payor device, communication inputs received within the communication interface via the at least one input device.

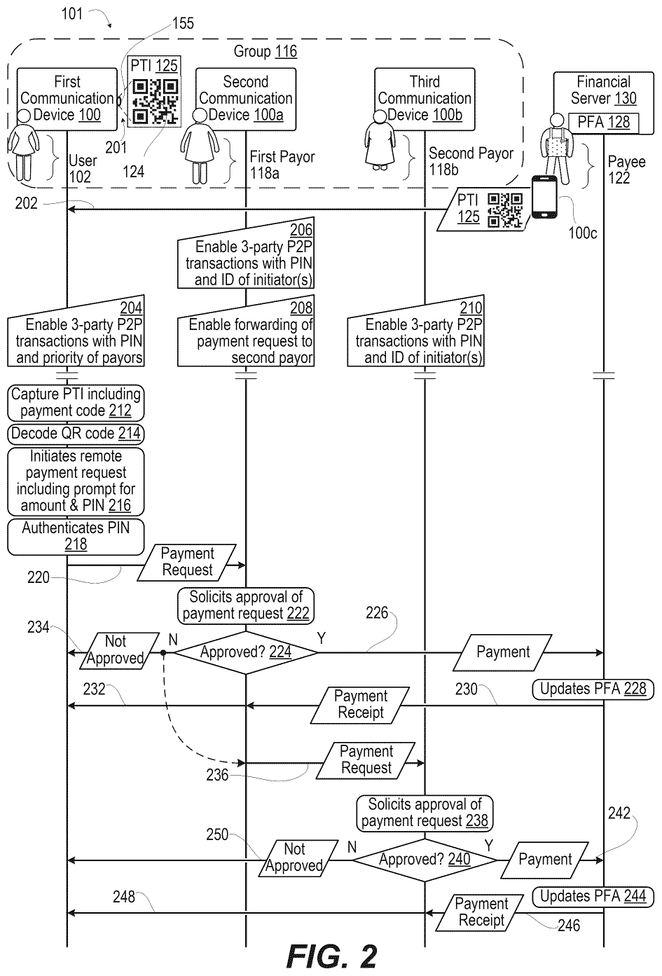

FIG. 2 is an example three-party communications timing diagram of communications environment 101 supporting distinct roles for initiator, payor, and payee to complete a P2P transaction. The present disclosure enables communication device 100 operated by user (e.g., user 102) to initiate a payment request that is authenticated and contains desired receiver (e.g., payee 122) and transaction terms for approval and processing of a payment by others (e.g., first payor 118a or second payor 118b). User 102 operates through communication device 100. First payor 118a operates through second communication device 100a. Second payor 118b operates through third communication device 100b. Financial server 130 manages payee financial account (PFA) 128 on behalf of payee 122. Payee 122 provides payment transaction information (PTI) 125 to communication device 100. In an example, PTI 125 is displayed. ICD 155 of communication device 100 captures an image of PTI 125. In another example, in operation 201, payee 122 has fourth communication device 100c that transmits PTI 125 to first communication device 100, such as via near field communication (NFC) transceivers respectively of first and fourth communication devices 100 and 100c as indicated by arrow 202.

In operation 204, in response to receiving PTI 125, communication device 100 is enabled to perform functionality of three-party P2P transaction with identified and prioritized payor(s) (e.g., first payor 118a and second payor 118b) in group 116. In operation 206, first payor 118a enables trusted family members (e.g., user 102) in group 116 to send payment requests with an indication of PIN authorization to second communication device 100a. In one or more embodiments, in operation 208, first payor 118a can select another trusted family member (e.g., second payor 118b) in group 116 for routing of payment requests to second communication device 100a when first payor 118a is unwilling, unable, or unavailable for approving the payment request. In one or more embodiments, in operation 208, communication device 100 can autonomously select another trusted family member (e.g., second payor 118b) in group 116 for routing of payment requests to second communication device 100a when payment request is not approved by first payor 118a or expires without a payment being applied within a threshold time period. In operation 210, second payor 118b enables trusted family members (e.g., user 102) in group 116 to send payment requests with an indication of PIN authorization to third communication device 100b.

In operation 212, while completing a POS transaction, user 102 triggers communication device 100 to capture PTI 125 that includes a payment code such as QR code 124. In block 214, communication device 100 decodes QR code 124. In block 216, communication device 100 initiates automatic generation of remote payment request in response to decoding QR code 124 by prompting user 102 via a user interface to enter an amount to be paid along with an optional note describing the purpose of the payment. In block 218, communication device 100 authenticates user 102 by requiring entry of PIN, and communication device 100 includes an indication of authentication with the payment request. As indicated at arrow 220, payment request is communicated from first communication device 100 to second communication device 100a. In response to receipt of payment request, in block 222, second communication device 100a solicits approval of the payment request by first payor 118a. When a determination is made in decision block 224 that first payor 118a has approved payment, second communication device 100a uses payment code to make a payment to financial server 130, as indicated at arrow 226. In process 228, financial server 130 updates PFA 128. Financial server 130 communicates a payment receipt, indicated via arrow 230, to second communication device 100a. As indicated via arrow 232, second communication device 100a relays the payment receipt to first communication device 100 to enable presenting of the receipt to payee 122. When a determination is made in decision block 224 that first payor 118a did not approve payment (i.e., first payor 118a declined payment or did not respond within a period of time), second communication device 100a communicates the corresponding status, at arrow 234, to first communication device 100 to enable manual or automatic resubmission of the payment request by first communication device 100 to third communication device 100b. Alternatively, second communication device 100a may manually or automatically forward the payment request, as indicated via arrow 236, to third communication device 100b.

In response to receipt of payment request, in process 238, third communication device 100b solicits approval of the payment request by second payor 118b. When a determination is made in decision block 240 that second payor 118b approved the payment, third communication device 100b uses payment code to make a payment to financial server 130, as indicated at arrow 242. In process 244, financial server 130 updates PFA 128. Financial server 130 communicates a payment receipt at arrow 246 to third communication device 100b. At arrow 248, third communication device 100b relays the payment receipt to first communication device 100 to enable presenting of the receipt to payee 122. When a determination is made in decision block 240 that second payor 118b did not approve payment (i.e., declined payment or did not respond within a period of time), third communication device 100b communicates the corresponding status, as indicated via arrow 250, to first communication device 100. For clarity, two payors (118a and 118b) are shown configured within group 116; However, it is appreciated that there may be only one payor or more than two payors within different embodiments of groups.

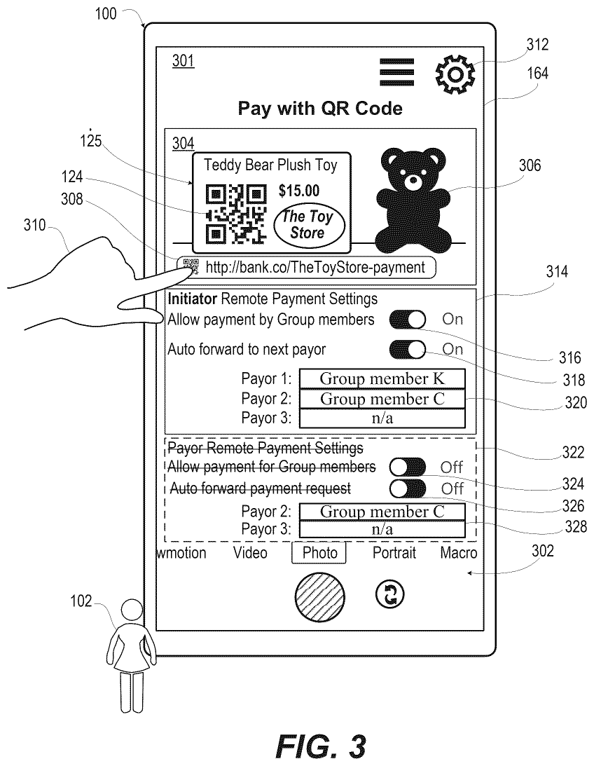

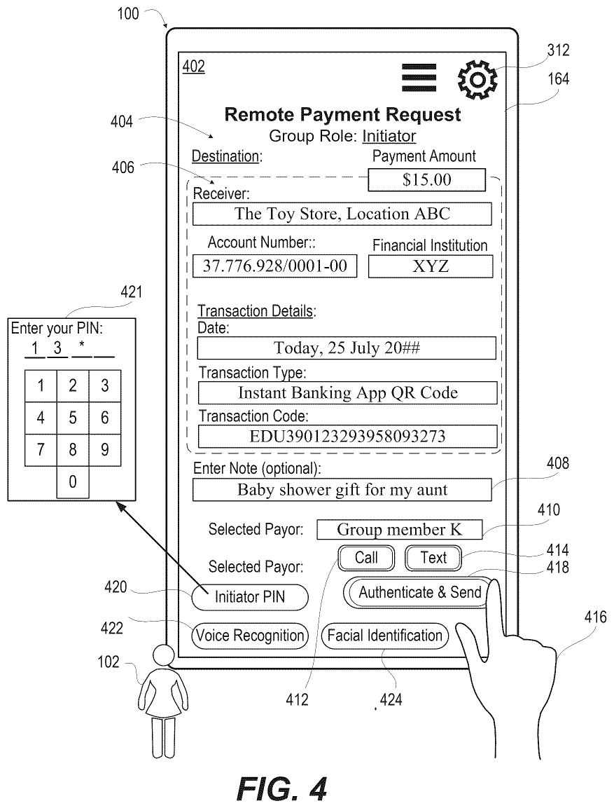

FIG. 3 illustrates display 164 of communication device 100 presenting pay with QR code window 301 configured for an initiator (i.e., user 102) within group 116 (FIG. 1). Camera controls 302 manage camera preview segment 304 that displays captured payment information. In an example, camera preview segment 304 presents product image 306 and payment transaction information 125, including QR code 124 and text: “Teddy Bear Plush Toy, $15.00, The Toy Store”. Communication device 100 decodes QR code 124, obtaining assigned payment code 308: “http://bank.co/TheToyStore-payment”. Payment code 308 is displayed as a control button. Left hand 310 of user 102 indicates selection or activation of payment code 308 to generate a remote payment request described below with regard to FIG. 4. With continuing reference to FIG. 3, remote payment settings control 312 enable editing of role-based settings. With user 102 being identified as an initiator within group 116 (FIG. 1), initiator remote payment setting (IRPS) segment 314 is presented. In an example, IRPS segment 314 presents first toggle control 316 to set whether to allow or not allow payment requests to group members (i.e., payors). IRPS segment 314 presents second toggle control 318 to select whether to automatically forward a payment request to an additional payor when a currently selected payor fails to approve a payment request. IRPS segment 314 presents payor selection controls 320 enabling prioritized selection of individuals within group 116 (FIG. 1) that are authorized to be a payor (e.g., first and second payors 118a and 118b). Though payer selection control 320 shows three additional payors, in one or more embodiments, the numbers of payers can be more or less. In one or more embodiment, the prioritization of payors can be based on category of item being purchased or paid for. As an example, within a family group, Dad may be associated as a primary payor for vehicle expenses, such as gasoline, while Mom is associated as a primary payor for clothing and meals.

If user 102 also performs the role of a payor within the group, then payor remote payment setting (PRPS) interface 322 would be presented in response to activating remote payment settings control 312. In an example, PRPS interface 322 presents first toggle control 324 to allow or not allow payment requests from group members (i.e., initiators). In some embodiments, this selection can include an additional window presenting a listing of the group members and selectable options to granularly select which members of the group can submit payment requests and/or which members cannot. PRPS interface 322 presents second toggle control 326 to automatically forward a payment request to an additional payor (e.g., second payor 118b of FIG. 1) when payor (e.g., first payor 118a of FIG. 1) declines, or selects a forward option for, or fails to timely approve a payment request. PRPS interface 322 presents payor selection controls 328 enabling prioritized selection of individuals within group 116 (FIG. 1) that are also authorized to be a payor (e.g., second payor 118b). It is appreciated that the user interface features associated with a payor can be similarly incorporated into and presented on a payor only device, such as first communication device 100a.

FIG. 4 illustrates display 164 of communication device 100 presenting remote payment request (RPR) window 402 configured for an initiator (i.e., user 102) within group 116 (FIG. 1). Payment information 404 is at least in part automatically captured by communication device 100. In an example, communication device 100 decodes a QR code and performs optical character recognition (OCR) on text in a camera preview image to directly obtain, or to associate with additional information for payment destination and transaction details 406. In an example payment information 404 includes:
(i) payment amount: $15.00;
(ii) Receiver: The Toy Store, Location ABC;
(iii) Receiver Account Number: 37.776.928/0001-00;
(iv) Receiver Financial Institution: XYZ
(v) Date: Today, 25 July 20##;
(vi) Transaction Type: Instant Banking App QR Code;
(vii) Transaction Code: EDU390123293958093273;

Payment information 404 may be manually modified or expanded upon by inputs by user 102. In an example, user 102 may enter contextual information justifying or explaining the purchase request, such as note 408 that provides “baby shower gift for my aunt”. User 102 may change a selected payor using payor control 410 due to circumstances of the transaction, such as knowing who is available or who would be the most appropriate person to make payment. User 102 may use call control 412 or text control 414 when direct communication with the payor is deemed needed or helpful. Authenticate and send control 418 is displayed for triggering user authentication. First payor should be authenticated as part of group 116 (FIG. 1) and to have authority to make a payment. Initiator PIN control 420 is one example for triggering initiator authentication. In an example, PIN entry window 421 pops up in response to selecting initiator PIN control 420. Voice recognition control 422 and face identification control 424 enable alternative biometric authentication to initiator PIN control 420. Examples of user authentication inputs include visual, audio and touch inputs that support face recognition, PIN, voice recognition, private answer to a security question, fingerprint matching, retina pattern matching, encryption key device, etc. In an example, right hand 416 of user 102 activates authenticate and send control 418 to trigger authentication of entered initiator PIN with subsequent sending to selected payor if authenticated. Voice recognition control 422 and face identification control 424 enable alternative biometric authentication.

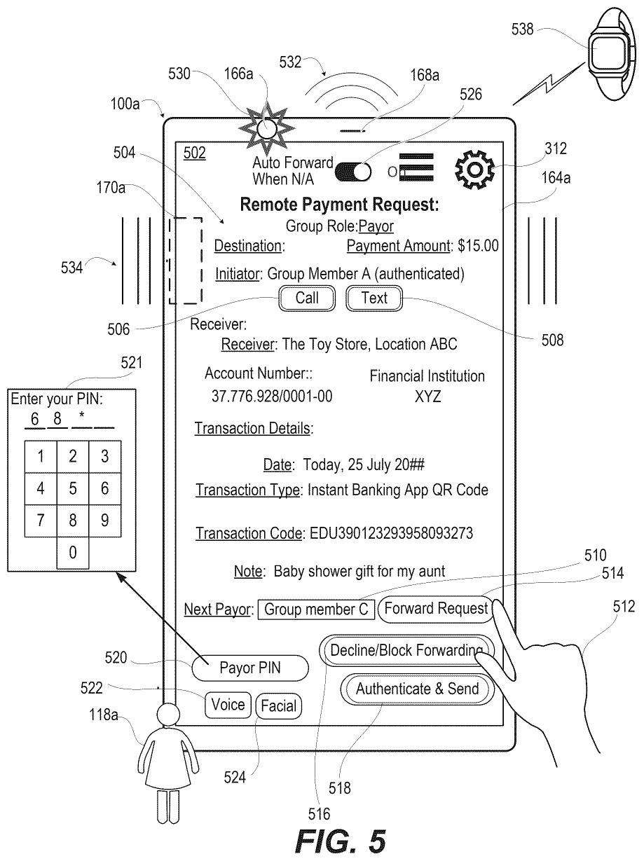

FIG. 5 illustrates display 164a of second communication device 100a presenting remote payment request (RPR) window 502 configured for a payor (i.e., first payor 118a) within group 116 (FIG. 1). Payment information 504 received from communication device 100 (FIG. 4) is presented to explain the context of the purchase request and to indicate authentication of the initiator (i.e., user 102 of FIG. 4). In an example, first payor 118a may use call control 506 or text control 508 when direct communication with the initiator is deemed needed or helpful. First payor 118a may change a selected payor using payor control 510 due to circumstances of the transaction. For example, first payor 118a can determine that second payor 118b (FIG. 1) is a more appropriate person to make the requested payment. To prompt a payment decision by first payor 118a, decision controls are displayed. In an example, the decision controls include forward request control 514, decline/block forwarding payment control 516, and authenticate and send payment control 518. Each control 514, 516, 518 triggers the corresponding described functionality. First payor should be authenticated as part of group 116 (FIG. 1) and to have authority to make a payment. Payor PIN control 520 is one example method/mechanism for triggering payor authentication. In an example, PIN entry window 521 pops up in response to selecting payor PIN control 520. Voice recognition control 522 and face identification control 524 enable alternative biometric authentication to payor PIN control 520. In an example, right hand 512 of first payor 118a activates either forward request control 514, decline/block forwarding payment control 516, or authenticate and send payment control 518 using payor PIN control 520 to authenticate and send payment. Auto forward control 526 may be enabled or disabled for automatically forwarding to the subsequent payor when the current payer (i.e., first payor 118a) is detected as being unable or declines to receive the request (e.g., second communication device 100a is in an off state or first payor 118a is busy and selects a decline option when the payment request notification is surfaced on the requested payor device). Auto forward control 526 may be enabled or disabled for automatically forwarding to the subsequent payor when the current payer (i.e., first payor 118a) is detected as failing to respond to the payment request after a threshold period of time from a time of receipt of the request by the payor communication device. In an example, first payor 118a inadvertently or intentionally does not make a payment decision (e.g., approved, declined, or forwarded). In one or more embodiments, second communication device 100a informs communication device 100 (FIG. 4) when a payment request is received. In one or more embodiments, second communication device 100a informs communication device 100 (FIG. 4) when a payment decision is made. In one or more embodiments, second communication device 100a informs communication device 100 (FIG. 4) when a payment request has been approved, resulting in a successful payment.

To increase the likelihood of getting the attention of first payor 118, various alert features can exist second communication device 100a. In an example, display 164a may be activated. Alternatively, or in addition, light 166a may be triggered to provide visual alert 530. Alternatively, or in addition, audio output devices 168a may be triggered to provide aural alert 532. Alternatively, or in addition, vibratory or haptic output device 168a may be triggered to provide vibration alert 534. In another example, a connected device (e.g., smart watch 538) may include visual, aural or tactile feedback devices that may be triggered. Communication device 100 and second communication device 100b may similarly provide alert features to respectively get the attention of user 102 and second payor 118b. In one or more embodiments, the i communication device 100 of user 102 (i.e., initiator or requestor) can remotely trigger or retrigger the various alert features on demand on second or third communication device 100a or 100b of respectively first payor 118a and second payor 118b.

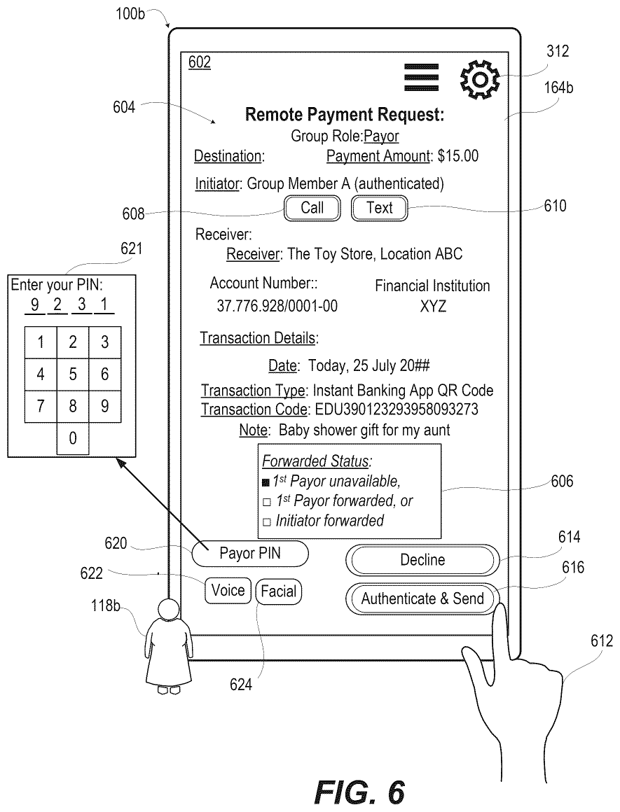

FIG. 6 illustrates display 164b of third communication device 100b presenting forwarded remote payment request (FRPR) window 602 configured for a subsequent payor (i.e., second payor 118b) within group 116 (FIG. 1). Display 164b may be identical to display 164a (FIG. 5) and for any subsequent payor. In an example, display 164b may differ in adding information about the context for why the payment was forwarded after being sent to a prior payor. Payment information 604 received from communication device 100 (FIG. 4) or second communication device 100a (FIG. 5) is presented to explain the context of the purchase request and to indicate authentication of the initiator (i.e., user 102 of FIG. 4). In addition, FRPR window 602 may include forwarding context information such as segment 606 that specifies whether a prior payor was unavailable, the prior payor forwarded the payment request, or an initiator selected the additional payor after initially selecting a prior payor. In one or more embodiments, the prior payor may enter a comment to accompany forwarding of the payment request to explain why the prior payor did not approve payment. With this context provided for why payment was not approved (i.e., payment not provided) or why the payment request was forwarded to a second payor, the subsequent payor (i.e., second payor 118b) may be more likely or less likely to approve payment. In an example, forwarding of the payment request by the initiator may occur subsequent to when the first payor has declined the payment request. The subsequent payor may infer that the first payor was not in favor of the purchase, particularly if the first payor had the opportunity to forward the payment request but did not. Conversely, receiving a manual or automatic forwarding of the payment request from the first payor may provide a neutral inference (i.e., no inference) since no action or omission of an action can be attributed to the first payor. However, in one embodiment, the forwarded request from the initiator may include metadata that notifies the second requested payor of the status of the initial transmission of the request to the first payor (e.g., declined or not approved or timed-out), which can be helpful information to provide in the event the second requested payor attempts to subsequently forward the request to the first requested payor. In an example, second payor 118b may use call control 608 or text control 610 when direct communication with the initiator is deemed needed or helpful. Payor PIN control 620 is one example method/mechanism for triggering payor authentication. In an example, PIN entry window 621 pops up in response to selecting payor PIN control 620. Voice recognition control 622 and face identification control 624 enable alternative biometric authentication to payor PIN control 620. In an example, right hand 612 of second payor 118b activates either decline payment control 614 or authenticate and send payment control 616 using payor PIN to authenticate and send payment.

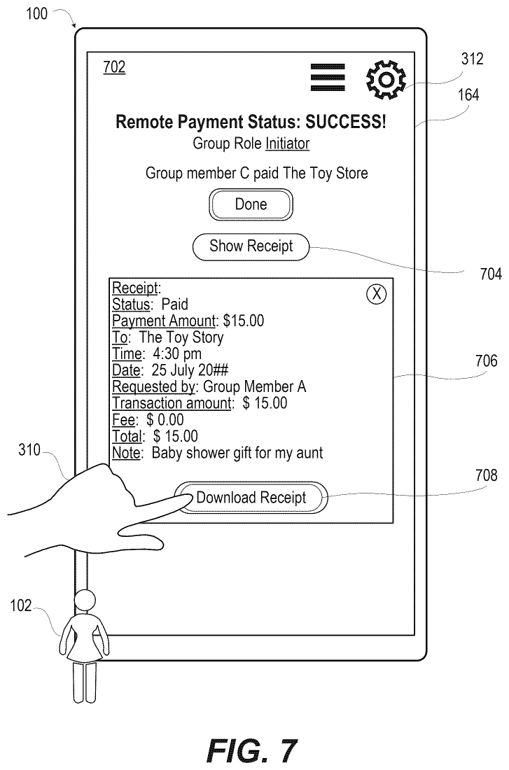

FIG. 7 illustrates display 164 of communication device 100 presenting remote payment request status (RPRS) window 702 configured for an initiator (i.e., user 102) within group 116 (FIG. 1). RPRS window 702 may indicate that the current request is pending at one of communication devices 100a, 100b associated with a payor. RPRS window 702 may indicate that the current request has been declined at one of communication devices associated with a payor. RPRS window 702 may indicate that the current request timed out due to failure to receive an approval, due to being decline or due to receiving a forwarding input at one of communication devices 100a, 100b associated with a payor. As depicted in FIG. 7, RPRS window 702 may indicate that the current request successfully resulted in the requested payment. In an example, triggering receipt control 704 presents receipt 706 that may be shown to a payee as immediate proof of payment. Triggering receipt download control 708 by left hand 310 of user 102 downloads and presents receipt 706. In one or more embodiments, receipt 706 may automatically be presented if received without the user having to take further action.

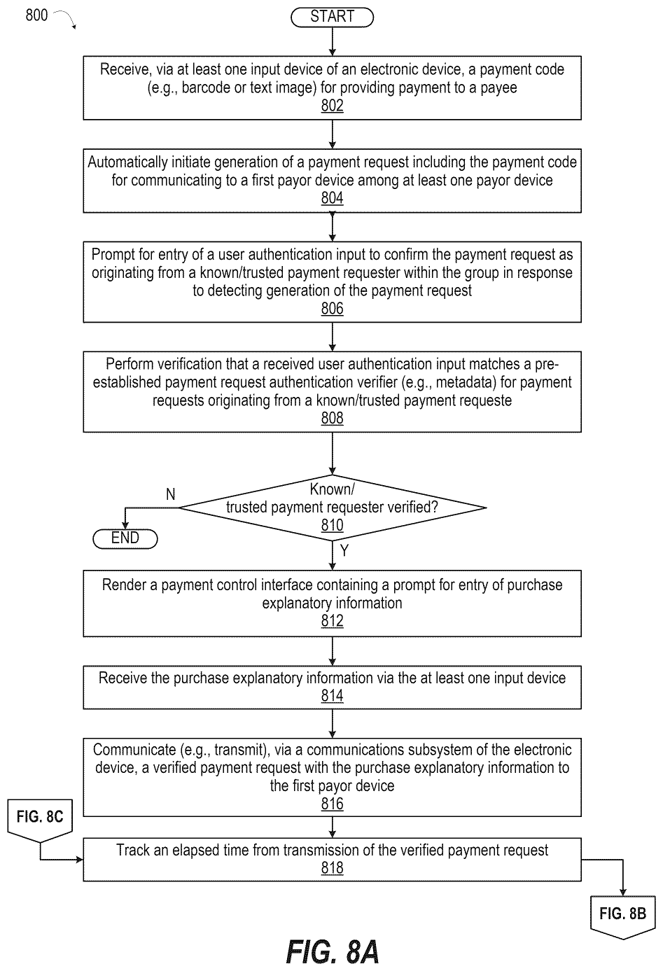

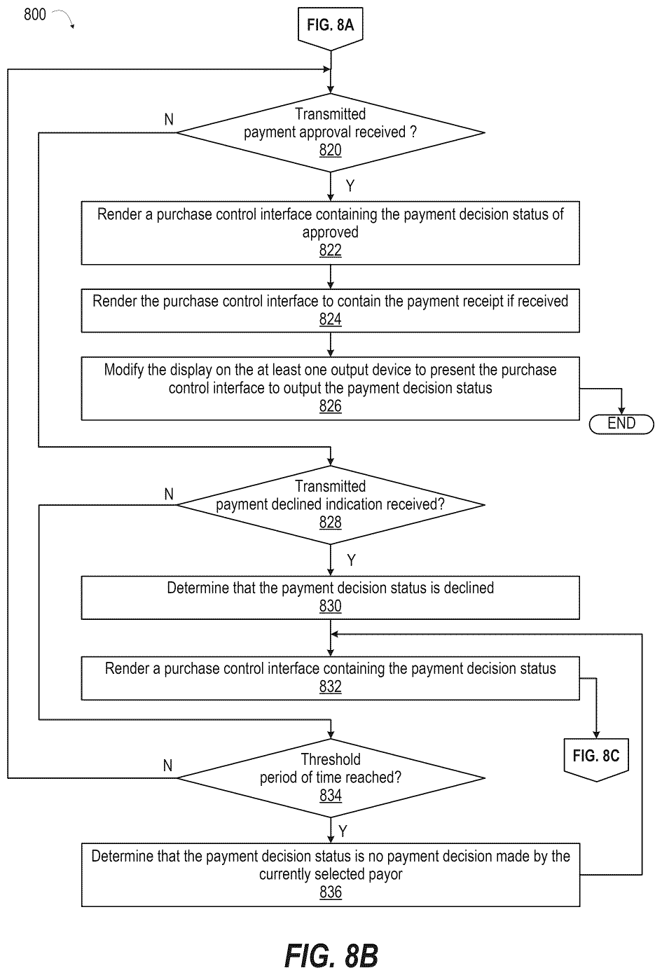

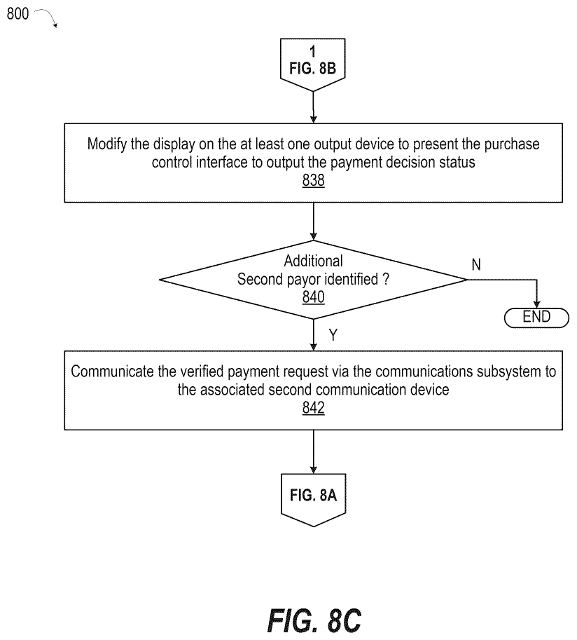

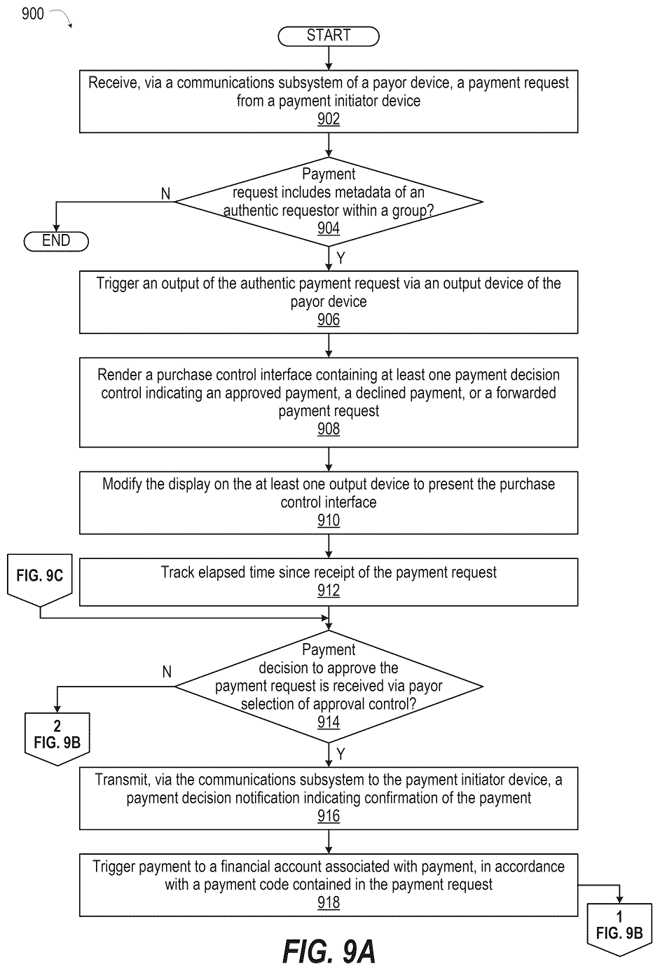

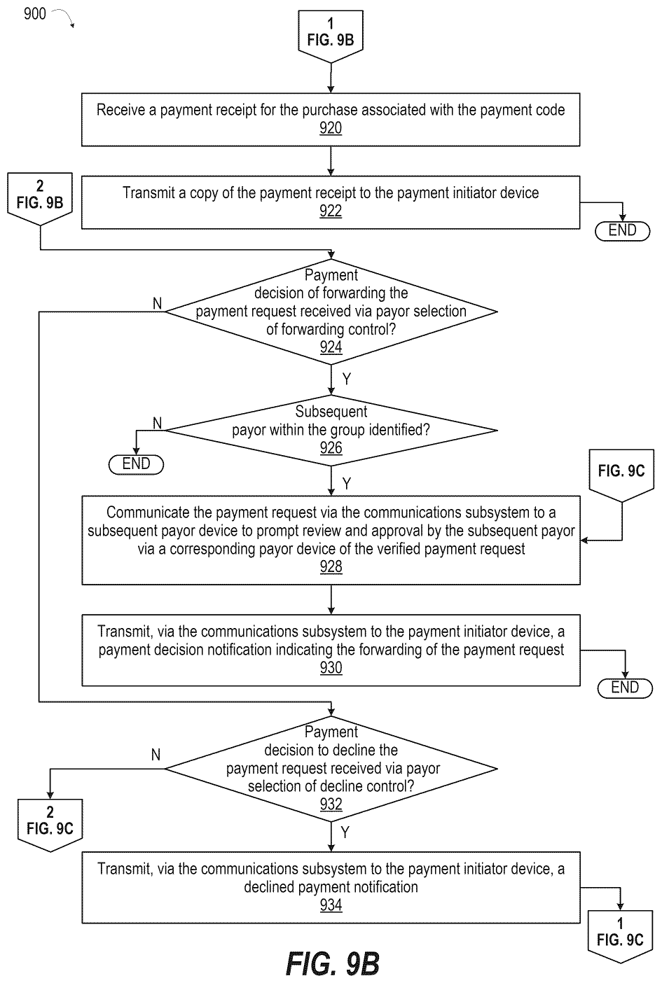

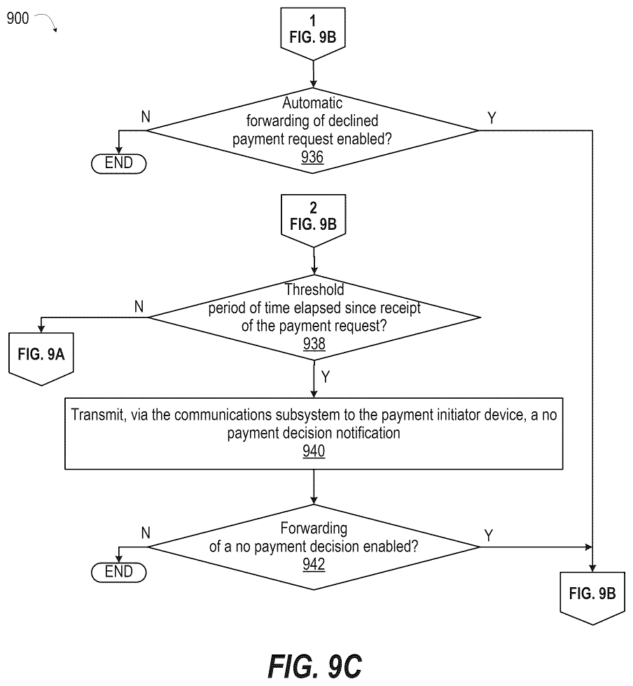

FIG. 8A-8C (collectively “FIG. 8”) are a flow diagram presenting method 800 for authenticating a payment requester as a trusted person and facilitating and expediting remote payor approval of a verified payment request by a purchaser engaged in a POS transaction with a payee. FIG. 9A-9B (collectively “FIG. 9”) are a flow diagram presenting method 900 for receiving a verified payment request from an initiator, who is a trusted person within a group that includes the requested payor, and responding by approving, declining, ignoring, or forwarding the payment request by the requested payor. The description of method 800 (FIG. 8) and method 900 (FIG. 9) is provided with general reference to the specific components illustrated within the preceding FIG. 1-7. Specific components referenced in method 800 (FIG. 8) and method 900 (FIG. 9) may be identical or similar to components of the same name used in describing preceding FIG. 1-7. In one or more embodiments, controller 120 (FIG. 1) configures communication devices 100, 100a and 100b (FIG. 1), or a similar computing device to provide the described functionality of method 800 (FIG. 8) and method 900 (FIG. 9).

With reference to FIG. 8A, method 800 includes receiving, via at least one input device of an electronic device, a payment code (e.g., barcode or text image) for providing payment to a payee (block 802). Method 800 includes automatically initiating generation of a payment request including the payment code for communicating to a first payor device among at least one payor device (block 804). Method 800 includes, in response to detecting generation of the authenticated payment request, prompting (i.e., outputting a prompt) for entry of a user authentication input to confirm the payment request as originating from a known/trusted payment requester within the group (block 806). Examples of user authentication inputs include visual, audio and touch inputs, which support face recognition, personal identification number (PIN), voice recognition, private answer to a security question, fingerprint matching, retina pattern matching, encryption key device, etc. Method 800 includes performing verification that a received user authentication input matches a pre-established payment request authentication verifier (e.g., metadata) for payment requests originating from a known/trusted payment requester (block 808). Method 800 includes determining whether a known/trusted payment requester is verified (decision block 810). In response to not verifying a known/trusted payment requester, method 800 ends.

In response to verifying that the payment requester is a known/trusted payment requester, in one or more embodiments, method 800 includes rendering a payment control interface containing a prompt for entry of purchase explanatory information (block 812). Method 800 includes receiving the purchase explanatory information via the at least one input device (block 814). Method 800 includes communicating (e.g., transmitting), via a communications subsystem of the electronic device, a verified payment request with the purchase explanatory information to the first payor device (block 816). According to one aspect of the disclosure, the receipt by the first payor device of the verified payment request dynamically triggers/causes an output of the authentic payment request via an output device of the first payor device. Method 800 includes tracking an elapsed time from transmission of the verified payment request (block 818). Then method 800 proceeds to block 820 of FIG. 8B.

With reference to FIG. 8B, method 800 includes determining whether a transmitted payment approval is received, via a communications subsystem, which may include a payment receipt (decision block 820). In response to determining that the transmitted payment approval is received, method 800 includes rendering a purchase control interface containing the payment decision status of approved (block 822). In one or more embodiments, method 800 includes rendering the purchase control interface to contain the payment receipt if received (block 824). Method 800 includes modifying the display on the at least one output device to present the purchase control interface to output the payment decision status (block 826). The initiating user may show the display to the payee as proof of payment for receiving the purchased product. Then method 800 ends. In response to determining that the transmitted payment approval is not received in decision block 820, method 800 includes determining whether a transmitted response/indication is received, via the communications subsystem, indicating that the payment has been declined (decision block 828). In response to determining that the transmitted indication of a declined payment request is received, method 800 includes determining that the payment decision status is declined (block 830). Method 800 includes rendering a purchase control interface containing the payment decision status (block 832). Then method 800 proceeds to block 838 of FIG. 8C.

With continued reference to FIG. 8B, in response to determining that the transmitted payment declined indication is not received in decision block 828 (FIG. 8B), method 800 includes determining whether a threshold period of time has been reached without receiving a payment decision from a currently selected payor (decision block 834). In response to determining that the threshold period of time has not been reached, method 800 returns to block 820. In response to determining that the period of time has been reached without receiving a transmitted payment decision (e.g., approved or declined), method 800 includes determining that the payment decision status is no payment decision made by the currently selected payor (e.g., not available) (block 836). Method 800 returns to block 832.

With reference to FIG. 8C, method 800 includes modifying the display on the at least one output device to present the purchase control interface to output the payment decision status (block 838). In one or more embodiments, method 800 may end (not shown). With continuing reference to FIG. 8C, in one or more embodiments, method 800 includes determining whether an additional second payor is identified based on either a current user input or an automatic setting in response to the payment decision status of not approved (e.g., declined or no payment decision within a threshold of time) (decision block 840). The additional second payor is within the group, and the additional second payor has an associated second payor device (e.g., third communication device 100b of FIG. 1). In response to determining that no additional second payor is identified, method 800 ends. In response to determining that the additional second payor is identified in decision block 840, method 800 includes communicating the verified payment request via the communications subsystem to the associated second communication device (e.g., third electronic device 100b of FIG. 1) of the at least one payor device designated as a second payor within the group to prompt review and approval by the additional second payor via a third electronic device of the purchase associated with the payment code (block 842). In one or more embodiments, an input by the requestor triggers communication of the verified payment request to the additional second payor. Then, method 800 returns to block 818 (FIG. 8A).

In one or more embodiments, the at least one input device is or includes an image capturing device. Method 800 further includes capturing a scanned image including the payment code. The scanned image is one of a one-dimensional barcode or a two-dimensional barcode containing payment information indicating a recipient account and a payment amount. Method 800 includes autonomously transmitting at least one of the scanned image and the payment information within the verified payment request to the first payor device only after receipt of the user input that matches the pre-established payment request authentication verifier. In one or more embodiments, method 800 includes capturing a plurality of character images as the payment code. Method 800 includes performing optical character recognition of the character images to identify a recipient account and a payment amount. Method 800 includes transmitting the recipient account and payment amount within the verified payment request to the first payor device.

In one or more embodiments, in response to receiving a communication request from the first payor device subsequent to communicating the verified payment request, method 800 includes rendering and outputting, via the at least one output device, a communication interface. Method 800 includes communicating, via the communications subsystem to the first payor device, inputs received within the communication interface via the at least one input device. Alternatively, or in addition, method 800 may include rendering and outputting, via the at least one output device, a communication interface in response to generating the verified payment request, enabling the user to initiate a communication and directly communicate with the payor either before or after transmitting the payment request.

With reference to FIG. 9A, method 900 includes receiving, via a communications subsystem of a payor device (e.g., second communication device 100a), a payment request from a payment initiator device (e.g., communication device 100) (block 902). Method 900 includes determining whether the payment request includes metadata that confirms that the payment request is an authentic request originating from a known/trusted payment requester (e.g., user 102) within a group (116) (decision block 904). In response to determining that the payment request does not include metadata that confirms that the payment request is an authentic request, method 900 ends. In response to determining that the payment request includes metadata that confirms that the payment request is an authentic request, method 900 includes triggering an output of the authentic payment request via an output device of the payor device (block 906). Method 900 includes rendering a purchase control interface containing at least one payment decision control indicating an approved payment, a declined payment, or a forwarded payment request (block 908). Method 900 includes modifying the display on the at least one output device to present the purchase control interface (block 910). Method 900 includes tracking elapsed time since receipt of the payment request (block 912).

Method 900 includes determining whether payment decision to approve the payment request is received via payor selection of approval control (decision block 914). In response to determining that payment decision to approve the payment request is received via payor selection of approval control, method 900 includes transmitting, via the communications subsystem to the payment initiator device, a payment decision notification indicating confirmation of the payment (block 916). Method 900 includes triggering payment to a financial account associated with payment, in accordance with a payment code contained in the payment request (block 918). In one or more embodiments, method 900 includes receiving a payment receipt for the purchase associated with the payment code (block 920). Method includes transmitting a copy of the payment receipt to the payment initiator device (block 922). Then method 900 ends.

In response to determining that payment decision to approve the payment request is not received via payor selection of approval control, in decision block 914, with reference to FIG. 9B, method 900 includes determining whether a payment decision of forwarding the payment request is received via payor selection of forwarding control (decision block 924). In response to determining that a selection of forwarding control to forward the payment request is received, method 900 includes determining whether a subsequent payor 118b within the group (116) is identified (block 926). In response to determining that a subsequent payor is not identified, method 900 ends. In response to determining that a subsequent payor is identified, method 900 includes communicating the payment request via the communications subsystem to a subsequent payor device to prompt review and approval by the subsequent payor via a corresponding payor device of the verified payment request (block 928). Method 900 includes transmitting, via the communications subsystem to the payment initiator device, a payment decision notification indicating the forwarding of the payment request (block 930). Then method 900 ends.

In response to determining that payment decision to forward the payment request is not received in decision block 924, method 900 includes determining whether a payment decision to decline the payment request is received via payor selection of decline control (decision block 932). In response to determining that payment decision to decline the payment request is received via payor selection of decline control, method 900 includes transmitting, via the communications subsystem to the payment initiator device, a declined payment notification (block 934). Method 900 includes determining whether automatic forwarding of declined payment request is enabled (decision block 936). In response to determining that forwarding of the declined payment request is enabled, method 900 returns to block 928. In response to determining that forwarding of the declined payment request is not enabled, method 900 ends. In response to determining that payment decision to decline the payment request is not received via payor selection of decline control, in decision block 932, method 900 includes determining whether a threshold period of time has elapsed since receipt of the payment request (decision block 938). In response to determining that the threshold period of time has not elapsed since receipt of the payment request, method 900 returns to block 914 (FIG. 9A). In response to determining that the threshold period of time has elapsed since receipt of the payment request, method 900 includes transmitting, via the communications subsystem to the payment initiator device, a no payment decision notification (block 940). Method 900 includes determining whether forwarding of a no payment decision is enabled (decision block 942). In response to determining that forwarding of a no payment decision is enabled, method 900 returns to block 928. In response to determining that forwarding of a no payment decision is not enabled, method 900 ends.

According to aspects of the present disclosure, the communication device 100 (FIG. 1), method 800 (FIG. 8), and computer program product, such as RSD 152 (FIG. 1), facilitate and expedite remote payor approval of a payment request by an initiator. In one or more embodiments, the initiator makes the payment request while at a payee point of sale. According to aspects of the present disclosure, with reference to FIG. 1, a communication device 100 operated by user 102 who lacks means or authority to make a payment includes third-party payment module 110. When executed by controller 120, third-party payment module 110 configures communication device 100 to send an initiator-verified and informative request for payment to an authorized payor (118a or 118b) within group 116. Third-party payment module 110 empowers user 102 (i.e., initiator) to quickly make a compelling request that captures a context of the request and to convey the authenticity of the request to the payor (118a or 118b) at a corresponding payor device (100a or 100b). Instances of inadvertently denied legitimate remote payment requests are reduced. Conversely, malevolent third parties who are not able to authenticate a remote payment request with proper credentials as a verified initiator within group 116 are thwarted, avoiding an ill-advised payment approval for an illegitimate remote payment request. The present disclosure provides features for when a particular payor is unavailable or unable to make the payment as requested by enabling set-up of a prioritized list of potential payors with group 116 to whom user 102 can forward the payment request.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. An electronic device comprising:
at least one input device;
at least one output device;
a memory comprising third-party payment module for coordinated remote purchase by at least one third-party payor;
a communications subsystem that links the electronic device to one or more second electronic devices designated as part of a group comprising at least one initiator device and at least one payor device; and
a controller communicatively coupled to the at least one input device, the at least one output device, the memory, and the communications subsystem, and which is configured to cause the electronic device to:
receive, via the at least one input device, a payment code for providing payment to a payee; and
in response to receiving the payment code:
automatically initiate generation of a payment request comprising the payment code for communicating to a first payor device among the at least one payor device; and
in response to detecting generation of the payment request:
prompt for entry of a user authentication input to confirm the payment request as originating from a known/trusted payment requester within the group;
verify, via the third-party payment module that a received user authentication input matches a pre-established payment request authentication verifier for payment requests originating from the known/trusted payment requester; and
transmit, via the communications subsystem, a verified payment request to the first payor device only after receipt of the user input that matches the pre-established payment request authentication verifier, the verified payment request comprising metadata that confirms that the payment request is an authentic request originating from the known/trusted payment requester and triggers an output of the authentic payment request via an output device of the first payor device.

2. The electronic device of claim 1, wherein the controller is further configured to cause the electronic device to:
receive, via the communications subsystem, a transmitted payment decision status from among a payment confirmation notification or a declined payment notification from the first payor device; and
output the received payment decision status via one or more of the at least one output device.

3. The electronic device of claim 2, wherein the at least one output device comprises a display, and to output the received payment decision status, the controller is further configured to cause the electronic device to:
render a purchase control interface containing the payment decision status; and
modify the display on the at least one output device to present the purchase control interface.

4. The electronic device of claim 3, wherein the controller is configured to cause the electronic device to:
in response to determining that the received payment decision status indicates a declining of the payment by the first payor:
identify a second payor within the group, the second payor having an associated second payor device; and
communicate the verified payment request via the communications subsystem to the second payor device to prompt review and approval by the second payor via the second payor device of the verified payment request.

5. The electronic device of claim 3, wherein the controller is configured to cause the electronic device to:
receive a payment receipt for the purchase associated with the payment code; and
in response to receiving the payment receipt:
render the purchase control interface containing the payment receipt; and
modify the display on the at least one output device to present the purchase control interface to enable viewing of the payment receipt confirming completion of the payment.

6. The electronic device of claim 1, wherein the at least one input device comprises an image capturing device, and the controller is configured to cause the electronic device to:
capture a scanned image comprising the payment code, the scanned image being one of a one-dimensional barcode or a two-dimensional barcode containing payment information indicating a recipient account and a payment amount; and
autonomously transmit at least one of the scanned image and the payment information within the verified payment request to the second electronic device only after receipt of the user input that matches the pre-established payment request authentication verifier.

7. The electronic device of claim 1, wherein the at least one input device comprises an image capturing device, and the controller is configured to cause the electronic device to:
capture a plurality of character images as the payment code;
perform optical character recognition of the character images to identify a recipient account and a payment amount; and
transmit the recipient account and payment amount within the verified payment request to the second electronic device.

8. The electronic device of claim 1, wherein the controller is configured to cause the electronic device to:
prior to communicating the payment code, render a payment control interface containing a prompt for entry of purchase explanatory information;
receive the purchase explanatory information via the at least one input device; and
communicate the verified payment request with the purchase explanatory information.

9. The electronic device of claim 1, wherein the controller is configured to cause the electronic device to:
in response to determining that a received payment decision status has not been received during a threshold period of time:
communicate the payment code via the communications subsystem to a third electronic device of the at least one second electronic device designated as a second payor and part of the group to prompt review and approval by the second payor via the third electronic device of the purchase associated with the payment code.

10. The electronic device of claim 1, wherein the controller is configured to cause the electronic device to:
in response to receiving a communication request from the first payor device subsequent to communicating the verified payment request:
render and output, via the at least one output device, a communication interface responsive to the communication request; and
communicate, via the communications subsystem to the first payor device, communication inputs received within the communication interface via the at least one input device.

11. A method comprising:
receiving, via at least one input device of an electronic device, a payment code for providing payment to a payee; and
in response to receiving the payment code:
automatically initiating generation of a payment request comprising the payment code for communicating to a first payor device among at least one payor device; and
in response to detecting generation of the payment request:
prompting for entry of a user authentication input to confirm the payment request as originating from a known/trusted payment requester within the group;
verifying that a received user authentication input matches a pre-established payment request authentication verifier for payment requests originating from a known/trusted payment requester; and
transmitting, via a communications subsystem of the electronic device, a verified payment request to the first payor device only after receipt of the user input that matches the pre-established payment request verifier, the verified payment request comprising metadata that confirms that the payment request is an authentic request originating from the known/trusted payment requester and triggers an output of the authentic payment request via an output device of the first payor device.

12. The method of claim 11, wherein the at least one output device comprises a display, and to output a received payment decision status, and the method further comprises:
receiving, via the communications subsystem, a transmitted payment decision status from among a payment confirmation notification or a declined payment notification from the first payor device; and
outputting the received payment decision status via one or more of the at least one output device.

13. The method of claim 12, wherein the at least one output device comprises a display, and to output the received payment decision status, the method further comprises:
rendering a purchase control interface containing the payment decision status;
modifying the display on the at least one output device to present the purchase control interface; and
in response to determining that the received payment decision status indicates a declining of the payment by the first payor:
identifying a second payor within the group, the second payor having an associated second payor device; and
communicating the verified payment request via the communications subsystem to the second payor device to prompt review and approval by the second payor via the second payor device of the verified payment request.

14. The method of claim 12, wherein the at least one output device comprises a display, and to output the received payment decision status, the method further comprises:
rendering a purchase control interface containing the payment decision status;
modifying the display on the at least one output device to present the purchase control interface;
receiving a payment receipt for the purchase associated with the payment code; and
in response to determining that the payment receipt is received:
rendering the purchase control interface containing the payment receipt; and
modifying the display on the at least one output device to present the purchase control interface to enable viewing of the payment receipt confirming completion of the payment.

15. The method of claim 11, wherein the at least one input device comprises an image capturing device, and the method further comprises:
capturing a scanned image comprising the payment code, the scanned image being one of a one-dimensional barcode or a two-dimensional barcode containing payment information indicating a recipient account and a payment amount; and
autonomously transmitting at least one of the scanned image and the payment information within the verified payment request to the first payor device only after receipt of the user input that matches the pre-established payment request authentication verifier.

16. The method of claim 11, wherein the at least one input device comprises an image capturing device, and the method further comprises:
capturing a plurality of character images as the payment code;
performing optical character recognition of the character images to identify a recipient account and a payment amount; and
transmitting the recipient account and payment amount within the verified payment request to the first payor device.

17. The method of claim 11, further comprising:
prior to communicating the payment code, rendering a payment control interface containing a prompt for entry of purchase explanatory information;
receiving the purchase explanatory information via the at least one input device; and
communicating the verified payment request with the purchase explanatory information.

18. The method of claim 11, further comprising:
in response to determining that a received payment decision status has not been received during a threshold period of time:
communicating the payment code via a communications subsystem of the electronic device to a third electronic device of the at least one payor device designated as a second payor and part of the group to prompt review and approval by the second payor via a third electronic device of a payment associated with the payment code.

19. The method of claim 11, further comprising:
in response to receiving a communication request from the first payor device subsequent to communicating the verified payment request:
rendering and outputting, via the at least one output device, a communication interface responsive to the communication request; and
communicating, via the communications subsystem to the first payor device, communication inputs received within the communication interface via the at least one input device.

20. A computer program product comprising:
a computer readable storage device; and
program code on the computer readable storage device that when executed by a processor associated with an electronic device, the program code configures the electronic device to provide functionality of:
receiving, via at least one input device of an electronic device, a payment code for providing payment to a payee; and
in response to receiving the payment code:
automatically initiating generation of a payment request comprising the payment code for communicating to a first payor device among at least one payor device; and
in response to detecting generation of the payment request:
prompting for entry of a user authentication input to confirm the payment request as originating from a known/trusted payment requester within the group;
verifying that a received user authentication input matches a pre-established payment request authentication verifier for payment requests originating from a known/trusted payment requester; and
transmitting, via a communications subsystem of the electronic device, a verified payment request to the first payor device only after receipt of the user input that matches the pre-established payment request authentication verifier, the verified payment request comprising metadata that confirms that the payment request is an authentic request originating from the known/trusted payment requester and triggers an output of the authentic payment request via an output device of the first payor device.
